(19) United States
(12) Patent Application Publication
(10) Pub. No.: US 2012/0171984 A1
(43) Pub. Date: Jul. 5, 2012

(54) HELP MESSAGE TRANSMISSION METHOD AND ELECTRONIC DEVICE IMPLEMENTING THE METHOD

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/095,934

(22) Filed: Apr. 28, 2011

(30) Foreign Application Priority Data
Dec. 29, 2010 (CN) 201010612878.2

(51) Int. Cl. H04M 11/04

(52) U.S. Cl. 455/404.1

(57) ABSTRACT

The disclosure provides a help message transmission method and an electronic device implementing the method. The electronic device stores a reference value and a phonebook, which records a plurality of phone numbers of contacts and places of registration of SIM cards associated with the phone numbers. The method includes steps: sensing an action and generating a sensed signal, analyzing the sensed signal and generating a characteristic parameter value of the action, evaluating whether the characteristic parameter value reaches the reference value, if yes, acquiring a position information of the electronic device and at least one phone number whose place of registration covers the position of the electronic device from the phonebook according to the position information, generating a help message according to the position information and the phone number, and sending a wireless signal of the help message to the at least one phone number.

### BACKGROUND

1. Technical Field

The present disclosure relates to electronic devices and, particularly, to a help message transmission method and an electronic device implementing the method.

2. Description of Related Art

Accidents often happen, such as traffic accidents. However, when an accident happens, the victim may not receive a quick response if there is no other person within a certain range of the accident site.

Therefore, it is necessary to provide an electronic device and control method capable of overcoming the limitations described.

### BRIEF DESCRIPTION OF THE DRAWINGS

FIG. 1 is a block diagram of an electronic device, according to an exemplary embodiment.

FIG. 2 is a block diagram of a control unit of the electronic device of FIG. 1, according to an exemplary embodiment.

FIG. 3 is a flowchart of a method for transmitting a help message, according to an exemplary embodiment.

### DETAILED DESCRIPTION

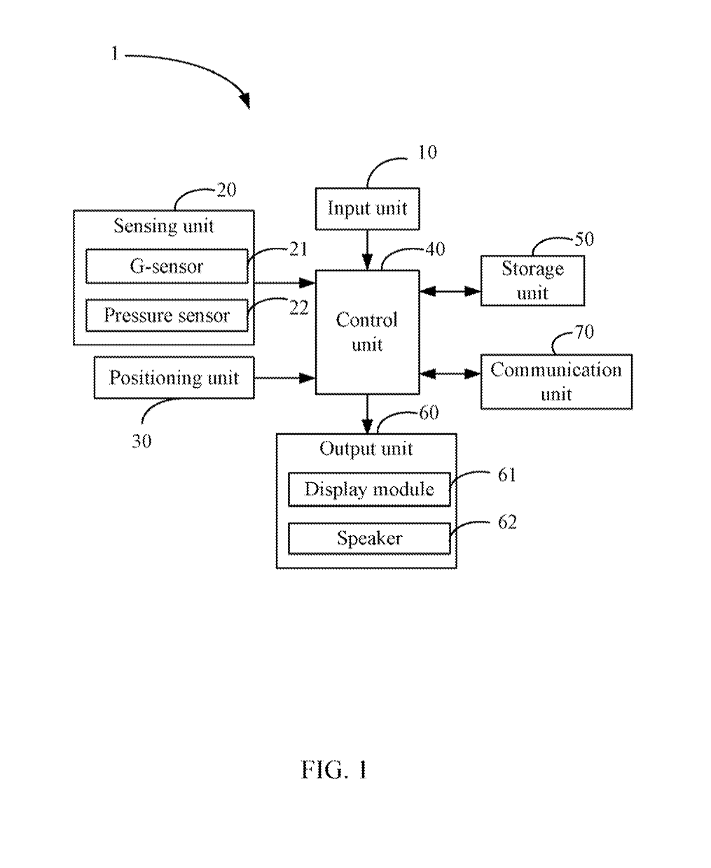

FIG. 1 is a block diagram of an electronic device, according to an exemplary embodiment. The electronic device 1 may be a portable device, such as a mobile phone and a PDA. The electronic device 1 includes an input unit 10, a sensing unit 20, a positioning unit 30, a control unit 40, a storage unit 50, an output unit 60, and a communication unit 70. The input unit 10 is configured for generating input signals in response to user inputs. The output unit 60 is configured for outputting information. The communication unit 70 is configured for communicating with other electronic devices. The storage unit 50 is configured for storing a reference value and a phonebook, which records a plurality of phone numbers of contacts and places of registration of SIM cards associated with the phone numbers.

The positioning unit 30 is configured for updating position information of the electronic device 1 in real time. In the embodiment, the positioning unit 30 is a GPS (Global Positioning system). For example, when the electronic device 1 is positioned in Shenzhen, the positioning unit 30 updates that the position information of the electronic device 1 as Shenzhen, and when the electronic device 1 is positioned in Shanghai, the positioning unit 30 updates that the position information of the electronic device 1 as Shanghai.

The sensing unit 20 is configured for sensing an action of the electronic device 1 and generating a sensed signal. Because the user carries the electronic device 1, the action of the electronic device 1 indirectly represents the action of the user. The action of the electronic device 1 includes, but is not limited to, a roll action, a shake action, a collision action, and/or a pressure being applied. For example, when the sensing unit 20 senses that the action of the electronic device 1 is the roll action, that means that the user of the electronic device 1 suffers from a traffic accident. When the sensing unit 20 senses that the action of the electronic device 1 is the pressure action, this means that the user has become suddenly ill. In the embodiment, the sensing unit 20 includes a G-sensor 21 and/or a pressure sensor 22. The G-sensor 21 is configured for sensing the roll/shake/collision action and generating the sensed signal. The pressure sensor 22 is configured for sensing the pressure action and generating the sensed signal.

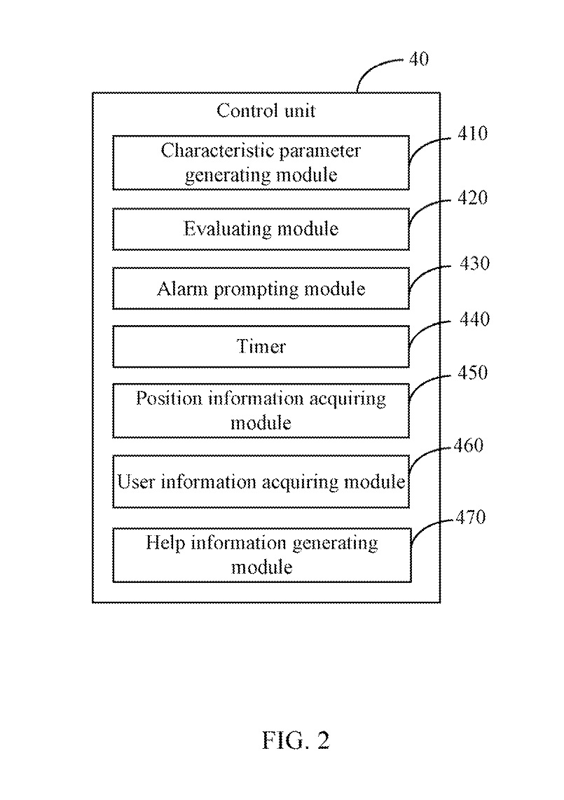

As shown in FIG. 2, the control unit 40 further includes a characteristic parameter generating module 410, an evaluating module 420, a position information acquiring module 450, a user information acquiring module 460, and a help information generating module 470.

The characteristic parameter generating module 410 is configured for analyzing the sensed signal from the sensing unit 20 and generating a characteristic parameter value of the action. In the embodiment, the characteristic parameter value may be an acceleration value from the G-sensor 21 or a pressure value from the pressure sensor 22. The evaluating module 420 is configured for evaluating whether the characteristic parameter value reaches the reference value in the storage unit 50. When the characteristic parameter value reaches the reference value, the position information acquiring module 450 is configured for acquiring position information of the electronic device 1 from the positioning unit 30. The user information acquiring module 460 is configured for acquiring at least one phone number whose place of registration covers the position of the electronic device 1 from the phonebook in the storage unit 50 according to the position information. For example, when the position information of the electronic device 1 is Shenzhen, the user information acquiring module 460 acquires the phone numbers whose SIM card is registered in Shenzhen.

The help message generating module 470 is configured for generating a help message according to the position information from the position information acquiring module 450 and the phone number from the user information acquiring module 460, and controlling the communication unit 70 to send a wireless signal of the help message to the at lease one phone number. For example, the help message is about “I have had a traffic accident at Jianshe road in Shenzhen, please come quickly to help me, thanks.” Therefore, when the user of another electronic device receives the help message, he/she can quickly get help for the user of the electronic device 1.

In another embodiment, the control unit 40 further includes an alarm prompting module 430 and a timer 440. When the characteristic parameter value of the action reaches the reference value, the alarm prompting module 430 is configured for controlling the output unit 60 to output an alarm prompting information to notify the user of the electronic device 1. The output unit 60 further includes a display module 61 and a speaker 62. The display module 61 is configured for displaying the alarm prompting information, for example, the display module 61 displays that you are in danger. The speaker 62 is configured to output a warning alarm in accordance with the alarm prompting information.

The timer 440 is configured for timing. When the output unit 60 outputs the alarm prompting information, the timer 440 starts to measure time and the evaluating module 420 is further configured for evaluating whether a response signal from the input unit 10 is received in a predetermined time period, such as 2 minutes. When the evaluating module 420 receives the response signal in response to user inputs from the input unit 420, that means that a wrong operation on the electronic device 1 has happened and leads to the characteristic parameter value of the action reaching the reference value, therefore, the electronic device 1 does not send the help message. For example, when the electronic device 1 drops on the ground through carelessness, the electronic device 1 senses the collision action and the characteristic parameter value of the action reaches the reference value. When the response signal is not received in the predetermined time period, that means that the user of the electronic device 1 is in danger, the electronic device 1 sends the help message as above described.

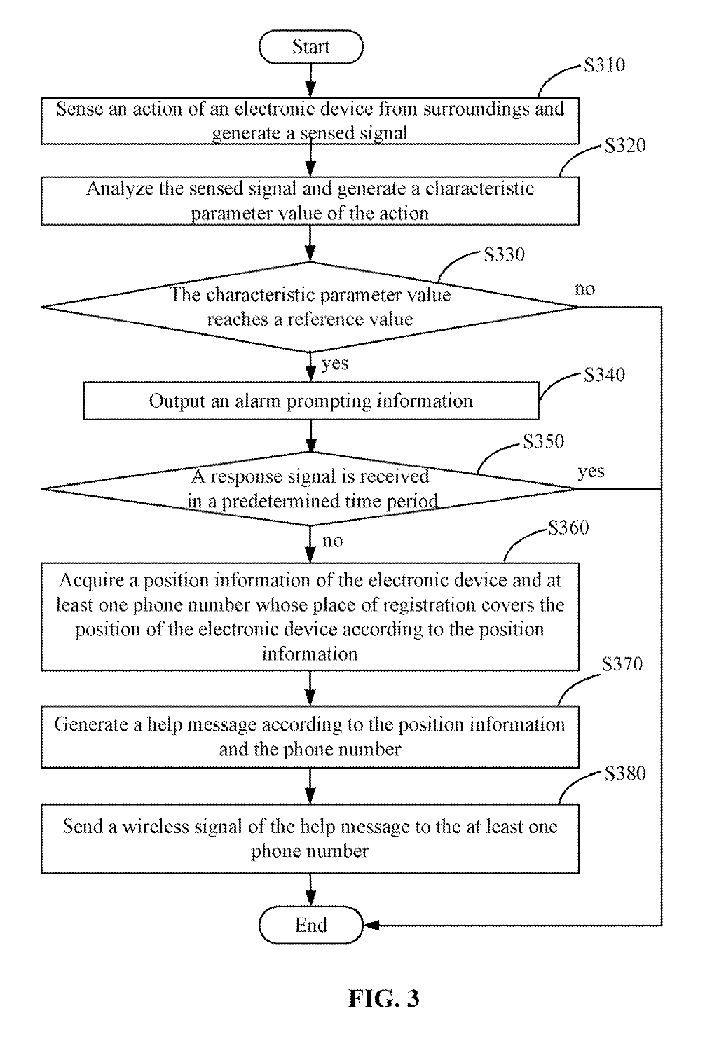

FIG. 3 is a flowchart of a method for transmitting a help message, according to one exemplary embodiment. In step S310, the sensing unit 20 senses the action of the electronic device and generates the sensed signal. In step S320, the characteristic parameter generating module 410 analyzes the sensed signal and generates the characteristic parameter value of the action.

In step S330, the evaluating module 420 evaluates whether the characteristic parameter value reaches the reference value in the storage unit 50, if the characteristic parameter value does not reach the reference value, the procedure returns to S310. If the characteristic parameter value reaches the reference value, in step S340, the alarm prompting module 430 controls the output unit 60 to output the alarm prompting information.

In step S350, the timer 440 starts to measure time and the evaluating module 420 evaluates whether the response signal from the input unit 10 is received in the predetermined time period, if the response signal is received in the predetermined time period, the procedure stops. If the response signal is not received in the predetermined time period, in step S360, the position information acquiring module 450 acquires the position information of the electronic device 1 and the user information acquiring module 460 acquires the at least one phone number whose place of registration covers the position of the electronic device 1 from the phonebook in the storage unit 50 according to the position information. In step S370, the help message generating module 470 generates the help message according to the position information and the phone number. In step S380, the help message generating module 470 sends the wireless signal of the help message to the at least one phone number in accordance with the user information.

Although the present disclosure has been specifically described on the basis of the exemplary embodiment thereof, the disclosure is not to be construed as being limited thereto. Various changes or modifications may be made to the embodiment without departing from the scope and spirit of the disclosure.

1. An electronic device for transmitting a help message, comprising:
a positioning unit for updating position information of the electronic device in real time;
a communication unit for communicating with other electronic devices;
a sensing unit for sensing a pressure action of the electronic device from surroundings and generating a sensed signal;
a storage unit for storing a reference value and a phonebook which records a plurality of phone numbers of contacts and places of registration of SIM cards associated with the phone numbers; and
a control unit for analyzing the sensed signal from the sensing unit and generating a characteristic parameter value of the action, when the characteristic parameter value reaches the reference value from the storage unit, acquiring the position information of the electronic device and at least one phone number whose place of registration covers the position of the electronic device from the phonebook in the storage unit according to the position information, generating a help message according to the position information and the acquired phone number, and controlling the communication unit to send a wireless signal of the help message to the at least one phone number.

2-5. (canceled)

6. A method for transmitting a help message by an electronic device, wherein the electronic device communicates with other electronic devices, and stores a reference value and a phonebook which records a plurality of phone numbers of contacts and places of registration of SIM cards associated with the phone numbers, the method comprising:
sensing a pressure action of the electronic device from surroundings and generating a sensed signal;
analyzing the sensed signal and generating a characteristic parameter value of the action;
evaluating whether the characteristic parameter value reaches the reference value;
if the characteristic parameter value reaches the reference value, acquiring a position information of the electronic device and at least one phone number whose place of registration covers the position of the electronic device from the phonebook in the storage unit according to the position information;
generating a help message according to the position information and the phone number; and
sending a wireless signal of the help message to the at least one phone number.

7-8. (canceled)
